(19) United States
(12) Patent Application Publication
(10) Pub. No.: US 2025/0330746 A1
(43) Pub. Date: Oct. 23, 2025

(54) SOUND EMISSION CONTROL DEVICE

(71) Applicant: YAMAHA CORPORATION, Hamamatsu-shi (JP)

(72) Inventors: Shunsuke NUMANO, Iwata-shi (JP); Kenta IOKU, Hamamatsu-shi (JP)

(21) Appl. No.: 19/073,600

(22) Filed: Mar. 7, 2025

(30) Foreign Application Priority Data
Apr. 19, 2024 (JP) 2024-068316

(51) Int. Cl. H04R 1/34

(52) U.S. Cl. CPC H04R 1/345

(57) ABSTRACT

A sound emission control device includes: a diffuser having a tapered shape. The diffuser has a front end portion configured to face a sound emitting surface of a diaphragm. The sound emission control device further includes a first waveguide having a first opening portion. The first opening portion is configured to surround a central axis of the diaphragm, to pass a sound emitted from the diaphragm, and to propagate the sound toward the diffuser. The distance between an edge of the first opening portion and the central axis changes along a circumferential direction around the central axis.

### CROSS-REFERENCE TO RELATED APPLICATIONS

The present application claims priority to Japanese Patent Application No. 2024-068316, filed Apr. 19, 2024. The contents of the application is incorporated herein by reference.

### BACKGROUND

### Technical Field

The present disclosure relates to a sound emission control device that controls the directivity of a speaker.

### Background Art

A speaker such as a dynamic speaker, which causes a diaphragm to vibrate, has a strong directivity in the front direction. For this reason, in electronic musical instruments and the like, a sound emission control device referred to as a diffuser is placed in front of the speaker to diffuse the sound emitted from the speaker. For example, in the sound emission control device disclosed in Japanese Utility Model Publication No. 3241907, a cone-shaped diffuser whose front end faces a diaphragm is placed in front of a speaker.

### SUMMARY OF THE INVENTION

In some speakers, such as speakers dedicated to mid-range reproduction, the speaker is required to allow sound in a specific frequency range to be heard at a desired sound pressure. However, the conventional sound emission control device mentioned above has a problem in that it is difficult to adjust the sound such that sound in a specific frequency range is heard at a desired sound pressure.

The present disclosure has been made in view of the circumstances described above. An example object of the present disclosure is to provide a sound emission control device that is capable of adjusting a sound such that sound in a specific frequency range is heard at a desired sound pressure.

The present disclosure provides a sound emission control device. The sound emission control device includes: a diffuser having a tapered shape. The diffuser has a front end portion configured to face a sound emitting surface of a diaphragm. The sound emission control device further includes a first waveguide having a first opening portion. The first opening portion is configured to surround a central axis of the diaphragm, to pass a sound emitted from the diaphragm, and to propagate the sound toward the diffuser. The distance between an edge of the first opening portion and the central axis of the diaphragm changes along a circumferential direction around the central axis of the diaphragm.

### BRIEF DESCRIPTION OF THE DRAWINGS

FIG. 1 is a cross-sectional view of a sound emission control device, which is an embodiment of the present disclosure, and a speaker unit.

FIG. 2 is a plan view of the sound emission control device.

FIG. 3 is a cross-sectional view of the sound emission control device.

### DETAILED DESCRIPTION OF THE EMBODIMENTS

Hereinafter, embodiments of the present disclosure will be described with reference to the drawings.

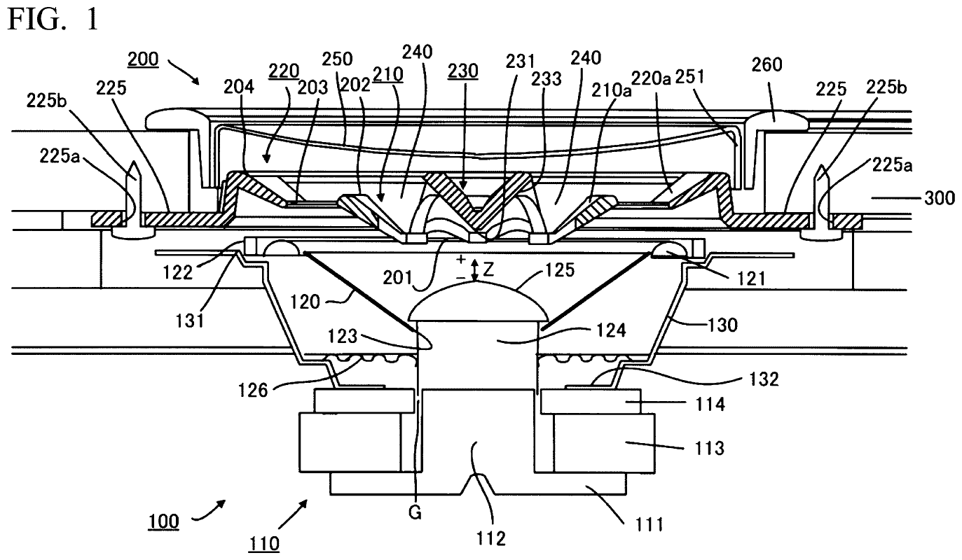

FIG. 1 is a cross-sectional view showing a configuration of a sound emission control device 200, which is an embodiment of the present disclosure, and a speaker unit 100 to which the sound emission control device 200 has been attached. The sound emission control device 200 and the speaker unit 100 are installed inside the casing of an electronic keyboard musical instrument.

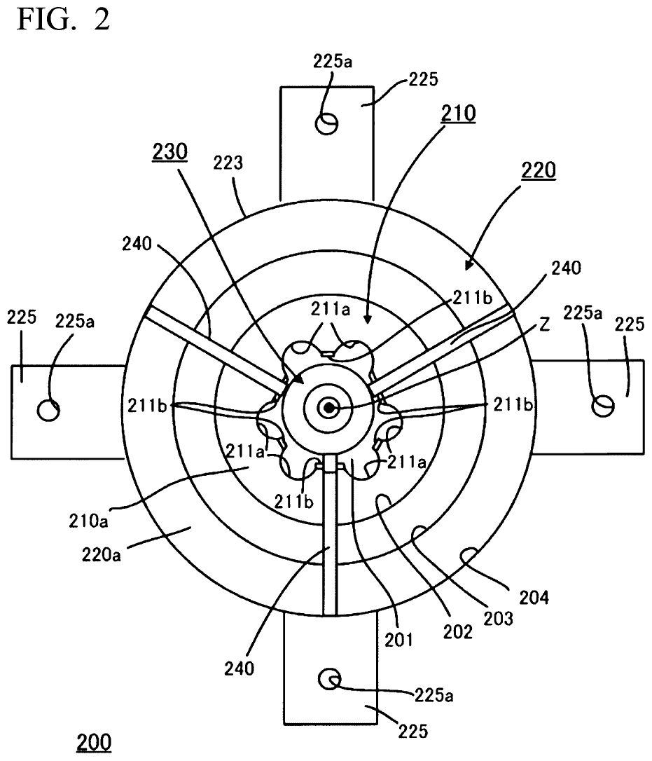

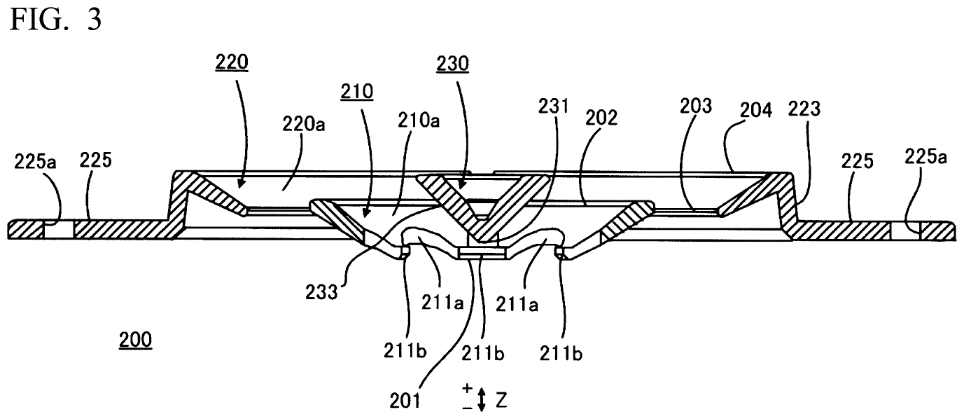

The speaker unit 100 is a device that emits sound by causing an axisymmetric, or more specifically, a cone-shaped diaphragm 120 to vibrate in a vibration axis Z direction. The speaker unit 100 according to the present embodiment is a squawker for mid-range reproduction. Furthermore, in the present embodiment, the central axis (or axis of symmetry) of the diaphragm 120 is the vibration axis Z. In the following description, the upper side in FIG. 1 is sometimes denoted the +Z side or the +Z direction, and the lower side is sometimes denoted the −Z side or the −Z direction. The same applies to FIG. 2 and FIG. 3 described below.

The upper portion of the diaphragm 120 is fixed to a circular bracket (frame) 122 by an edge 121. The edge 121 is an elastic member having an annular shape. A bottom portion of the diaphragm 120 has an opening portion 123. A hollow cone apex portion 124 having a cylindrical shape is inserted and fixed in the opening portion 123. Further, the cone apex portion 124, which is exposed from the opening portion 123 of the diaphragm 120 in the +Z direction, is covered by a dust cap 125 that is fixed to the diaphragm 120.

The side of the diaphragm 120 and the side of the cone apex portion 124 are surrounded by a frame 130. The frame 130 is a hollow tray-shaped member, and is fixed to the inside of the casing of the electronic keyboard musical instrument. The bracket 122 mentioned above is fixed to an opening portion 131 in the upper end of the frame 130. In addition, the outer wall of the cone apex portion 124 is fixed to the inner wall of the frame 130 by a spider 126, which is an elastic member.

The bottom portion 132 of the frame 130 has an opening portion. A lower end portion of the cone apex portion 124 passes through the opening portion of the bottom portion 132 in the-Z direction. A voice coil (not shown) is wound around the outer periphery of the lower end portion of the cone apex portion 124.

The speaker unit 100 includes a magnetic circuit 110. The magnetic circuit 110 includes a yoke 111, a pole piece 112, a magnet 113, and a plate 114. The yoke 111 has a disk shape and is perpendicular to the vibration axis Z. The pole piece 112 has a cylinder shape and protrudes from a central region of the yoke 111 in the +Z direction. The magnet 113 has an annular shape, surrounds the pole piece 112, and is stacked on a peripheral region of the yoke 111. The plate 114 has an annular shape and is stacked on the magnet 113. Further, the space between the inner surface of the plate 114 and the outer surface of an upper portion of the pole piece 112 forms a magnetic gap G that generates a magnetic field.

The surface of the plate 114 on the +Z side is fixed to the bottom portion 132 of the frame 130. Further, the voice coil on the bottom end portion of the cone apex portion 124 is inserted into the magnetic gap G. In the speaker unit 100, an electromagnetic force that drives the diaphragm 120 in the vibration axis Z direction is generated by energizing the voice coil, which causes the diaphragm 120 to emit sound.

The sound emission control device 200 includes a first waveguide 210, a second waveguide 220, a diffuser 230, three joining portions 240, a grille 250 and a substantially annular bracket (frame) 260.

The bracket 260 is inserted and fixed to a hole in a horizontal plate portion 300 inside the casing of the electronic keyboard musical instrument. The grille 250 is a substantially cylindrical member having a ceiling surface having a plurality of holes that allow sound to pass therethrough. The grille 250 is surrounded by a cylindrical edge 251 that extends to the lower end of the bracket 260. The edge 251 is fixed to the bracket 260.

FIG. 2 is a plan view when the sound emission control device 200 in FIG. 1 is viewed from the +Z side. FIG. 3 is a cross-sectional view of the sound emission control device 200 cut along a plane that includes the vibration axis Z.

Here, the first waveguide 210 is a member that has a substantially truncated cone-shaped and that includes an opening portion 201 on the −Z side, and a circular opening portion 202 on the +Z side that surrounds the opening portion 201 in a plan view (that is, when viewed from the Z-axis direction). Here, the opening portion 201 is a first opening portion (first opening) facing the sound emitting surface of the diaphragm 120. Further, the opening portion 202 is a circular opening portion in a position further away from the sound emitting surface than the opening portion 201. The sound emitting surface of the diaphragm 120 is a surface from which sound waves generated by the vibration of diaphragm 120 are emitted. In the present embodiment, the sound emitting surface of the diaphragm 120 includes, in addition to the surface of diaphragm 120 on the +Z side, which is exposed from the dust cap 125, the surface of dust cap 125 on the +Z side. The surface of the first waveguide 221 on the +Z side is an inclined surface 210a, which is inclined with respect to the vibration axis Z.

The opening portion 201 of the first waveguide 210 is a first opening portion that surrounds the vibration axis Z of the diaphragm 120, passes sound that is emitted from the diaphragm 120, and propagates the sound to the diffuser 230 side. In the present embodiment, the distance of the opening portion 201 from the vibration axis Z (the distance from an edge (outer edge) of the opening portion 201 to the vibration axis (central axis) Z) changes along the circumferential direction around the vibration axis Z.

More specifically, in the present embodiment, the opening portion 201 is configured by a plurality of edges surrounding the vibration axis Z, and some of the plurality of edges form notch portions 211a at which the distance from the vibration axis Z increases. The edges among the plurality of edges that are not notch portions 211aare referred to as edges 211b below. In the present embodiment, in the first opening portion 201, the notch portions 211a and the edges 211b alternatingly repeat along the circumferential direction about the vibration axis Z. Furthermore, the opening portion 201 of the present embodiment is provided with six substantially arc-shaped notch portions 211a, and the six notch portions 211a form a flower petal shape as a whole.

The second waveguide 220 includes a member that has a substantially truncated cone-shape and that includes a circular opening portion 203 on the −Z side, and a circular opening portion 204 on the +Z side that surrounds the opening portion 203 in a plan view (that is, when viewed from the Z-axis direction). Here, the opening portion 203 is a second opening portion (second opening) that surrounds the opening portion 201, which is a first opening portion. Furthermore, the second waveguide 220 is a waveguide having a second opening portion, and surrounds the first waveguide 210. The opening portion 203 is positioned approximately as far away from the sound emitting surface as the opening portion 202. The opening portion 204 is positioned further away from the sound emitting surface than the opening portion 203. In a similar manner to the first waveguide 210, the second waveguide 220 includes an inclined surface 220, which is inclined with respect to the vibration axis Z.

As shown in FIG. 2, the joining portions 240 are plate-shaped members that are radially arranged at intervals of 120 degrees about the vibration axis Z. The joining portions 24 join the diffuser 230 with a region of the first waveguide 210 that are sandwiched between two notch portions 211a (that is to say, the region facing the edge 211b), and further join the region to the second waveguide 220.

The diffuser 230 is a tapered member with a front end portion 231 that is made to face the sound emitting surface of the diaphragm 120. Specifically, in the diffuser 230, the front end portion 231 has a pointed cone shape. An inclined surface 233 forming the outer surface of the diffuser 230 is supported by the first waveguide 210 and the second waveguide 220 via the joining portions 240. The first waveguide 210 and the second waveguide 220 have shapes that are tilted toward the diffuser 230 side.

The edge portion 223 has an upper end that surrounds the opening portion 204 of the second waveguide 220, and extends in the −Z direction. Leg portions 225 protrude from four points on the lower end of the edge portion 223 toward the side of the edge portion 223. The leg portions 225 are each formed having a screw hole 225a. In the present example, the sound emission control device 200 is fixed to the plate portion 300 inside the casing of the electronic keyboard musical instrument as shown in FIG. 1 by inserting screws 225b into the screw holes 225a.

In the present embodiment, a portion of the sound emitted from the sound emitting surface of the diaphragm 120 passes through the opening portion 201 of the first waveguide 210, and is diffused in a horizontal direction by the diffuser 230. A portion of the sound that is diffused by the diffuser 230 is guided to the inclined surface 210a inside the first waveguide 210, and then propagated to the outside from the grille 250. Furthermore, the remaining portion of the sound that is diffused by the diffuser 230 is guided to the inclined surface 220a inside the second waveguide 220, and then propagated to the outside from the grille 250.

In addition, the remaining portion of the sound that has been emitted from the sound emitting surface of the diaphragm 120, that is to say, the sound that does not pass through the opening portion 201, passes through the rear side of the first waveguide 210, and is guided to the inclined surface 220a inside the second waveguide 220, and then propagated to the outside from the grille 250.

In the present embodiment, the plurality of notch portions 211a are provided in the opening portion 201. These notch portions 211a are areas that lack the material that blocks the passage of sound. For this reason, the opening portion 201 provided with the notch portions 211a allows sound in a specific frequency band (specifically, mid-range sound) to pass through more easily than an opening portion not provided with the notch portions 211a. As a result, in the present embodiment, an effect is obtained in which the sound pressure in the mid-range of the sound heard by a listener sitting to the side of the keyboard electronic musical instrument is increased.

As a result of trial and error, the inventors of the present application confirmed that the sound pressure in a specific frequency band can be changed by changing the area and shape of the notch portions 211a. Therefore, according to the present embodiment, it is possible to adjust a sound such that sound having a desired sound pressure in a specific frequency band is heard by a listener.

Furthermore, according to the present embodiment, a portion of the sound emitted from the sound emitting surface of the diaphragm 120 is guided by the first waveguide 210, and the remaining portion is guided by the second waveguide 220, and they are propagated to the outside from the grille 250. Therefore, according to the present embodiment, sound can be efficiently propagated to a listener that is sitting to the side of the electronic keyboard musical instrument.

### Other Embodiments

An embodiment of the present disclosure has been described above. However, other embodiments of the present disclosure are also possible. Examples of other embodiments include the following.

(1) In the embodiment described above, the opening portion 201, which is the first opening portion, has a flower petal shape including six notch portions 211a. However, the number of notch portions 211a is arbitrary. Furthermore, the overall shape of the first opening portion is not limited to a flower petal shape. Instead of providing the notch portions in the first opening portion having a perfect circular shape (or a circular shape), the overall shape of the first opening portion may be made a shape other than a perfect circle (or a circular shape). The first opening portion may be, for example, a star shape, a triangle shape, an oval shape, or the like.

(2) In the embodiment described above, the plurality of notch portions 211 each have the same shape and area. However, the shape or area of each notch portion 211a may be changed.

(3) The planar shapes of the diaphragm 120 and the bracket 260 surrounding the diaphragm 120 when viewed from the Z-axis direction do not have to be a perfect circular shape (or a circular shape), and may be, for example, an oval shape. In a case where the diaphragm 120 is made an oval shape, the sound pressure in the long axis direction becomes higher than the sound pressure in the short axis direction. Therefore, it is preferable to arrange the diaphragm 120 in an orientation such that the short axis direction of the diaphragm 120 coincides with the direction between the speaker unit 100 and the performer.

(4) A third waveguide that surrounds the second waveguide may be provided on the outside of the second waveguide.

(5) As disclosed in Japanese Unexamined Patent Application, First Publication No. 2020-118360, a concentric mesh that surrounds the second waveguide may be provided.

While preferred embodiments of the disclosure have been described and illustrated above, it should be understood that these are exemplary of the disclosure and are not to be considered as limiting. Additions, omissions, substitutions, and other modifications can be made without departing from the scope of the present disclosure. Accordingly, the disclosure is not to be considered as being limited by the foregoing description, and is only limited by the scope of the appended claims.

What is claimed is:

1. A sound emission control device, comprising:
a diffuser comprising a tapered shape, the diffuser comprising a front end portion being configured to face a sound emitting surface of a diaphragm; and
a first waveguide comprising a first opening portion, the first opening portion being configured to surround a central axis of the diaphragm, to pass a sound emitted from the diaphragm, and to propagate the sound toward the diffuser,
wherein a distance between an edge of the first opening portion and the central axis of the diaphragm changes along a circumferential direction around the central axis of the diaphragm.

2. The sound emission control device according to claim 1, wherein the first opening portion of the first waveguide is configured to be positioned between the diaphragm and the diffuser in a direction of the central axis of the diaphragm.

3. The sound emission control device according to claim 1, wherein the first opening portion comprises a notch portion at which the distance between the edge of the first opening portion and the central axis of the diaphragm increases.

4. The sound emission control device according to claim 1, further comprising:
a second waveguide that surrounds the first waveguide, the second waveguide comprising a second opening portion that surrounds the first opening portion.

5. The sound emission control device according to claim 1,
wherein the first opening portion comprises two notch portions at which the distance between the edge of the first opening portion and the central axis of the diaphragm increases, and
wherein the sound emission control device further comprises a joining portion that joins the diffuser and a region of the first waveguide, the region of the first waveguide being sandwiched by the two notch portions.

6. The sound emission control device according to claim 1,
wherein the first opening portion comprises a plurality of notch portions at which the distance between the edge of the first opening portion and the central axis of the diaphragm increases, and
wherein the sound emission control device further comprises a plurality of joining portions that respectively join the diffuser and a plurality of regions of the first waveguide, each of the plurality of regions of the first waveguide being sandwiched by two notch portions of the plurality of notch portions.

7. The sound emission control device according to claim 1,
wherein the first waveguide further comprises a second opening portion configured to surround the central axis of the diaphragm, and
wherein the first opening portion is disposed at a first distance from the sound emitting surface of the diaphragm, and the second opening portion is disposed at a second distance from the sound emitting surface of the diaphragm that is greater than the first distance from the sound emitting surface of the diaphragm.

8. The sound emission control device according to claim 7, wherein the first opening portion comprises a notch portion at which the distance between the edge of the first opening portion and the central axis of the diaphragm increases, and
wherein in the notch portion, the distance between the edge of the first opening portion and the central axis of the diaphragm increases from a first distance to a second distance and then decreases from the second distance to the first distance along the circumferential direction around the central axis of the diaphragm.
